(19) United States
(12) Patent Application Publication
(10) Pub. No.: US 2013/0091491 A1
(43) Pub. Date: Apr. 11, 2013

(54) Self-Documentation of Development Systems

(71) Applicants: Oleg Koutyrine, Dielheim (DE); Andrey Hoursanov, Mannheim (DE)

(72) Inventors: Oleg Koutyrine, Dielheim (DE); Andrey Hoursanov, Mannheim (DE)

(73) Assignee: SAP AG, Walldorf (DE)

(21) Appl. No.: 13/270,958

(22) Filed: Oct. 11, 2011

(51) Int. Cl. G06F 9/44

(52) U.S. Cl. 717/123

(57) ABSTRACT

The present disclosure involves systems, software, and computer implemented methods for providing self-documentation of development systems. One process includes operations for identifying at least one software component for deployment on a client device. An installation package is received from a source server, the installation package including the at least one software component and at least one artifact associated with the software component. Source documentation is generated for the at least one software component based on the at least one artifact.

### TECHNICAL FIELD

The present disclosure relates to software, computer systems, and computer implemented methods for providing self-documentation of development systems corresponding to a business scenario.

### BACKGROUND

Some software systems may be composed of smaller components. Software components may be partitioned according to their functionalities. In some instances, software components may be marketed, priced, sold, and delivered separately. For example, the software component may define an application programming interface (API) that provides access to a particular function of the software system. A concrete installation of a Java system comprises a combination of functionalities, representing a “business scenario.” In some instances, technical documentation may be generated for software components. For example, a standard technical documentation tool for generating documentation of Java source code is Javadoc. Javadoc may allow describing of Java elements by the developer of an API at design time and may generate documentation that is consumed by other developers who use the API. In some instances, the documentation is generated on the software component provider's side.

Technical documentation of software components may be helpful in certain situations. For example, in a layer-based deployment of software, documentation may be necessary for development of software components based on or using software components from other layers. One software provider may develop applications and APIs for a lower software layer. A consumer of this software may use the APIs from the lower layer to develop applications for a higher layer. In some instances, the consumer of the APIs may also provide applications to other consumers. A Java Development Kit (JDK) provider may supply a JDK as a lower layer application for a Java application developer at the higher layer, for example. In turn, the Java application developer may position a Java application as a platform or framework for other applications, and so forth. Accordingly, technical documentation of source code associated with each layer may be important for deployment of software components across multiple layers.

In other instances, technical documentation for a business scenario associated with a software installation is reviewed for integration of other functionalities into the software installation or to gain a better understanding of the software. In a vendor-customer scenario, a vendor may deliver applications in the form of binaries, or Java archives, to a customer. The customer may customize the applications by programming against the provided archives. Technical documentation for the archives may make it easier to understand the ideas behind the API in the archives as well as some aspects of consumption of the archives, such as concurrency or transactional behavior, which may be difficult to express in a programming language. In this instance, a single entry point to documentation, describing a system, may be desired. In other words, technical documentation may be beneficial in a number of different scenarios in which developers may need to review source code to develop other software components or applications based on a particular software component, to introduce additional functionality into the software component, or to apply the software components in an existing software system.

### SUMMARY

The present disclosure describes techniques for providing self-documentation of development systems. A computer program product is encoded on a tangible storage medium, where the product comprises computer readable instructions for causing one or more processors to perform operations. These operations can include identifying at least one software component for deployment on a client device. An installation package is received from a source server, the installation package including the at least one software component and at least one artifact associated with the software component. Source documentation is generated for the at least one software component based on the at least one artifact.

These and other embodiments can optionally include one or more of the following features. Generating source documentation is performed during deployment of the at least one software component or a portion of the at least one software component on the client device. Generating source documentation is performed in response to a request for a page of documentation associated with the at least one software component. Generating source documentation is performed as a background process at a predetermined time. Generating source documentation is performed in response to a change in a particular artifact associated with the software component.

Generating source documentation is performed during a restart of a platform associated with the at least one software component when a change has occurred to at least one artifact associated with the platform. Generating the source documentation includes resolving at least one unresolved reference to a particular document different from the artifact. Generating source documentation is performed by a Javadoc documentation generator. The software component represents a particular functionality of a software application comprised of a plurality of different software components.

The operations further include receiving an installation package for each of the plurality of different software components from a source server, each installation package including one of the plurality of different software components and at least one source artifact associated with the one of the plurality of different software components; and generating source documentation for each of the plurality of different software components based on the at least one source artifact associated with each of the plurality of different software components. The operations further comprise identifying a particular one of the plurality of different software components that is not designated for installation on the client device; and bypassing the particular software component when generating source documentation for each of the plurality of different software components. The source code documentation includes a Javadoc comment. The artifact is a source artifact or an intermediate artifact. The software component includes a binary file.

In a second general aspect, a computer program product is encoded on a tangible storage medium, where the product comprises computer readable instructions for causing one or more processors to perform operations that include identifying a software component for installation on a client device. At least one artifact associated with the software component is identified. The at least one artifact is packaged with a binary file associated with the software component for delivery to the client device for generation of source documentation of the software component at the client device.

These and other embodiments can optionally include one or more of the following features. The software component represents a particular functionality of a software application comprised of a plurality of different software components. The artifact includes at least one unresolved reference to a particular document different from the artifact. The at least one artifact is packaged with the binary file in a delivery unit including at least one of a Java Archive file, a Software Deployment Archive file, or a Software Component Archive file.

In a third general aspect, a computer program product is encoded on a tangible storage medium, where the product comprises computer readable instructions for causing one or more processors to perform operations that include identifying at least one software component for deployment on the system. An installation package is received from a source server, the installation package including the at least one software component and at least one source artifact or intermediate artifact associated with the software component. Source documentation is generated for the at least one software component based on the at least one source artifact or intermediate artifact.

These and other embodiments can optionally include the following feature. Generating source documentation includes determining a programming language associated with the at least one software component and the at least one source artifact or intermediate artifact; and selecting a documentation generator associated with the programming language for generating source documentation for the at least one software component.

While generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for providing self-documentation of development systems;

FIG. 2 illustrates a diagram of modules and data objects used to provide self-documentation of software components using an appropriate system, such as the system described in FIG. 1;

FIG. 3 is a flowchart of an example process for delivering software components to a client prior to generating documentation for the software components using an appropriate system, such as the system described in FIG. 1;

FIG. 4 is a flowchart of an example process for generating documentation for software components on a client system using an appropriate system, such as the system described in FIG. 1;

FIG. 5 is a diagram of objects, modules, and processes used to generate documentation from source artifacts for software components in a service-oriented architecture using an appropriate system, such as the system described in FIG. 1; and

FIG. 6 is a diagram of objects, modules, and processes used to generate documentation from intermediate artifacts for software components in a service-oriented architecture using an appropriate system, such as the system described in FIG. 1.

### DETAILED DESCRIPTION

This disclosure generally describes computer systems, software, and computer implemented methods for providing self-documentation of development systems corresponding to a business scenario. Technical documentation for certain software components is generated or published based on source artifacts or intermediate artifacts at a late stage of customer deployment of the same software components to capture updated information corresponding to the business scenario associated with the software component deployment. Source or intermediate artifacts are delivered together with binaries from a provider of the software component, such as a source server, to a client device. Based on the source or intermediate artifacts associated with particular software components that will be deployed on the client device, technical documentation for the software components is generated at the client device, instead of at the software component provider, for example, near or during deployment of the software component. Accordingly, technical documentation that is useful to a customer at the client device and that matches the customer's business scenario may be generated.

In some instances, development system documentation may be generated at a high level at the software component provider's location for an entire software application or system. In a Java-based implementation, for example, Java source files may be used as a source for technical documentation. The Java source files may be stored in one physical location and a technical documentation generator, such as a Javadoc compiler, is executed to produce Javadoc documentation for the stored Java source files. The Javadoc documentation may then be published to a particular platform, such as a web container for documentation in HyperText Markup Language (HTML) format, for example, or delivered to a client as an archive.

Generating technical documentation for development systems at a high level and at the provider side, however, may not meet user expectations with respect to technical documentation. In certain instances, users may expect completeness, accuracy, integrity, or usability with respect to technical documentation for software components. For example, with respect to completeness, a user may expect documentation for every function within a system. Similarly, for accuracy, the user may expect that the documentation only relate to parts currently present in the system. With respect to integrity, the user may expect that the documentation reflect relations between different parts of the system, and for usability, that there is a single entry point and system global context for the documentation independent of the amount of entities comprising the system. Technical documentation may be generated for an entire software system at a high level because it may be difficult to resolve documentation references and generate indexes at a lower level of granularity. The drawback of generating technical documentation at the provider, however, is that the technical documentation may not meet user expectations and may not provide documentation suitable for a customer's scope or business scenario.

Documentation at a coarse level of granularity may deliver substantial amounts of information to a customer, some of which may be irrelevant to the customer's needs. The customer may be slowed by having to search through the documentation for relevant information, for example. Generation of documentation at the provider and for the entire software system may also make it difficult to fill consistency gaps between software components and associated documentation while also preventing interconnection of software components after documentation is generated. Accordingly, the user may need to manually connect some software components.

Generating documentation at the customer side when the software component is deployed, however, provides documentation that matches the customer's expectations and business scenario. The software components that are designated for deployment at the customer's location are the software components for which technical documentation is generated and provided to the customer. Accordingly, the deployed software components are documented to meet the customer's accuracy expectation and so that the customer does not need to sift through documentation for software components unrelated to a particular installation instance. Further, the customer's completeness expectation is also met so that documentation associated with each installed software component is provided. Providing documentation at the customer's location in connection with a software deployment may also ensure consistency with software states of the system for which the software component is deployed. For example, updates to software components may automatically trigger updates to the documentation of the software components. Additionally, generating documentation at the customer's location in conjunction with deployment of software components allows resolution of references to other documentation based on up-to-date information.

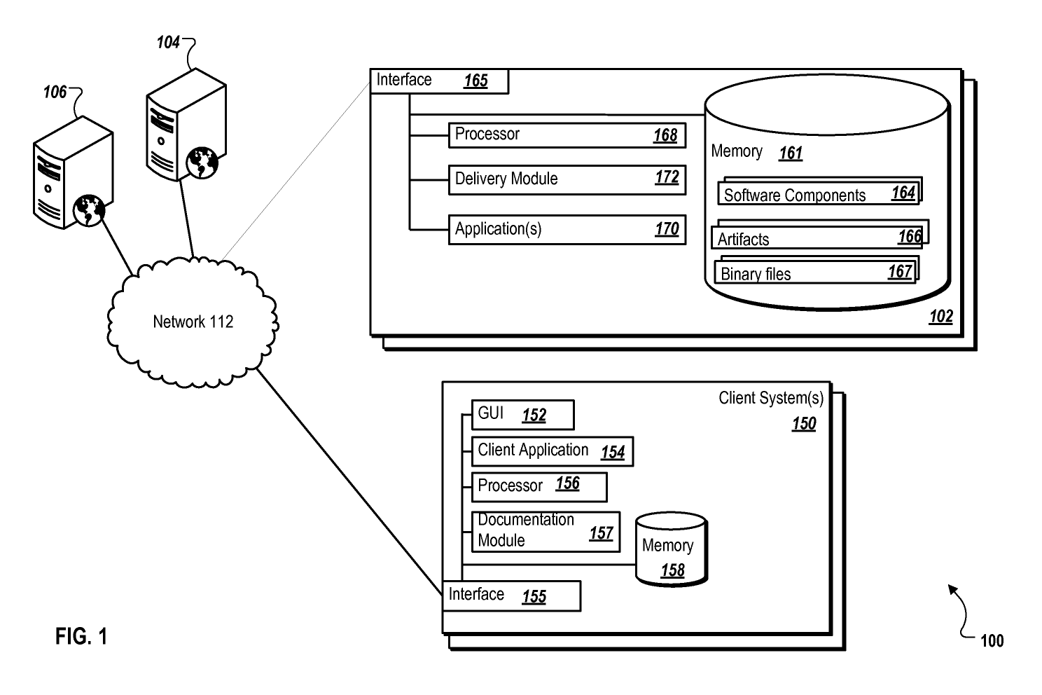

Turning to the illustrated example, FIG. 1 illustrates an example environment 100 for providing self-documentation of development systems corresponding to a particular business scenario. The illustrated environment 100 includes or is communicably coupled with one or more clients 150 and servers 102, 104, and 106, at least some of which communicate across network 112. In general, environment 100 depicts an example configuration of a system capable of automatically generating documentation of development systems based on intermediate artifacts for software components designated for deployment on a client system 150. In some implementations, the delivery module 172 at server 102 can be implemented as a hosted application on a server, such as server 102, accessible to a user at client 150 through a network 112. Further, the delivery module 172 and other services provided by server 102 can be distributed across multiple servers, such as servers 104 and 106, in a distributed cluster-based environment, for example. In a distributed cluster-based environment, one or more additional servers (e.g., servers 104 and 106) can be included in environment 100, each server having components similar to those depicted in FIG. 1 for server 102 and providing services associated with distributed applications hosted by the servers in the distributed cluster-based environment. In certain instances, client 150 and servers 102, 104, and 106 can be logically grouped within a cloud computing network. Accordingly, the system may be provided as an on-demand solution through the cloud computing network as well as a traditional server-client system or a local application at client 150. Alternatively, the delivery module 172 may be provided through a traditional server-client implementation or locally at client 150 without the need for accessing a hosted application through network 112.

In general, server 102 is any server that stores one or more applications 170, where at least a portion of the applications 170 are executed via requests and responses sent to users or clients within and communicably coupled to the illustrated environment 100 of FIG. 1. For example, server 102 may be a Java Platform, Enterprise Edition (JEE)-compliant application server that includes Java technologies such as Enterprise JavaBeans (EJB), JEE Connector Architecture (JCA), Java Messaging Service (JMS), Java Naming and Directory Interface (JNDI), and Java Database Connectivity (JDBC). In some instances, the server 102 may store a plurality of various applications 170, while in other instances, the server 102 may be a dedicated server meant to store and execute only a single application 170. In some instances, the server 102 may comprise a web server or be communicably coupled with a web server, where the application 170 represents one or more web-based applications accessed and executed via network 112 by clients 150 of the system to perform the programmed tasks or operations of the application 170.

At a high level, the server 102 comprises an electronic computing device operable to receive, transmit, process, store, or manage data and information associated with the environment 100. The server 102 illustrated in FIG. 1 can be responsible for receiving application requests from one or more client applications or business applications associated with clients 150 of environment 100, responding to the received requests by processing said requests in the associated application 170, and sending the appropriate response from the application 170 back to the requesting client application. The server 102 may also receive requests and respond to requests from other components on network 112. Alternatively, the application 170 at server 102 can be capable of processing and responding to requests from a user locally accessing server 102. Accordingly, in addition to requests from the external clients 150 illustrated in FIG. 1, requests associated with the application 170 may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single server 102, environment 100 can be implemented using one or more servers such as servers 104 and 106, as well as computers other than servers, including a server pool. Indeed, server 102 and client 150 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 and client 150 may be adapted to execute any operating system, including Linux, UNIX, Windows, Mac OS, or any other suitable operating system.

In the present implementation, and as shown in FIG. 1, the server 102 includes a processor 168, an interface 165, a memory 161, and one or more applications 170. The interface 165 is used by the server 102 for communicating with other systems in a client-server or other distributed environment (including within environment 100) connected to the network 112 (e.g., clients 150, as well as other systems communicably coupled to the network 112). Generally, the interface 165 comprises logic encoded in software and/or hardware in a suitable combination and operable to communicate with the network 112. More specifically, the interface 165 may comprise software supporting one or more communication protocols associated with communications such that the network 112 or interface's hardware is operable to communicate physical signals within and outside of the illustrated environment 100.

In some implementations, server 102 may include a user interface, such as a graphical user interface (GUI). The GUI comprises a graphical user interface operable to, for example, allow the user of the server 102 to interface with at least a portion of the platform for any suitable purpose, such as creating, preparing, requesting, or analyzing data, as well as viewing and accessing artifacts associated with business transactions. Generally, the GUI provides the particular user with an efficient and user-friendly presentation of business data provided by or communicated within the system. The GUI may comprise a plurality of customizable frames or views having interactive fields, pull-down lists, and buttons operated by the user. For example, GUI may provide interactive elements that allow a user to select from a list of suggested entries for input into a data field displayed in GUI. More generally, GUI may also provide general interactive elements that allow a user to access and utilize various services and functions of application 170. The GUI is often configurable, supports a combination of tables and graphs (bar, line, pie, status dials, etc.), and is able to build real-time portals, where tabs are delineated by key characteristics (e.g. site or micro-site). Therefore, the GUI contemplates any suitable graphical user interface, such as a combination of a generic web browser and command line interface (CLI) that processes information in the platform and efficiently presents the results to the user visually.

Generally, example server 102 may be communicably coupled with a network 112 that facilitates wireless or wireline communications between the components of the environment 100 (i.e., between the server 102 and clients 150), as well as with any other local or remote computer, such as additional clients, servers, or other devices communicably coupled to network 112 but not illustrated in FIG. 1. In the illustrated environment, the network 112 is depicted as a single network in FIG. 1, but may be a continuous or discontinuous network without departing from the scope of this disclosure, so long as at least a portion of the network 112 may facilitate communications between senders and recipients.

Network 112 may be all or a portion of an enterprise or secured network, while in another instance at least a portion of the network 112 may represent a connection to the Internet. In some instances, a portion of the network 112 may be a virtual private network (VPN), such as, for example, the connection between client 150 and server 102. Further, all or a portion of network 112 can comprise either a wireline or wireless link. Example wireless links may include 802.11a/b/g/n, 802.20, WiMax, and/or any other appropriate wireless link. In other words, network 112 encompasses any internal or external network, networks, sub-network, or combination thereof operable to facilitate communications between various computing components inside and outside the illustrated environment 100. The network 112 may communicate, for example, Internet Protocol (IP) packets, Frame Relay frames, Asynchronous Transfer Mode (ATM) cells, voice, video, data, and other suitable information between network addresses. Network 112 may also include one or more local area networks (LANs), radio access networks (RANs), metropolitan area networks (MANs), wide area networks (WANs), all or a portion of the Internet, and/or any other communication system or systems at one or more locations. Network 112, however, is not a required component of the present disclosure, and the elements hosted by server 102 may be implemented locally at a client 150 or locally at server 102.

Client(s) 150 may have access to resources such as server 102 within network 112. In certain implementations, the servers within the network 112, including server 102 in some instances, may comprise a cloud computing platform for providing cloud-based services. The terms “cloud,” “cloud computing,” and “cloud-based” may be used interchangeably as appropriate without departing from the scope of this disclosure. Cloud-based services can be hosted services that are provided by servers such as 102, 104, and 106 and delivered across a network to a client platform to enhance, supplement, or replace applications executed locally on a client computer. Clients 150 can use cloud-based services to quickly receive software upgrades, applications, and other resources that would otherwise require a lengthy period of time before the resources can be delivered to clients 150. Additionally, other devices may also have access to cloud-based services, such as on-demand services provided by servers accessible through network 112. A cloud platform deployment implementation, however, is not a required element of the present disclosure, and other distributed infrastructures such as cluster-based systems can also be used.

As illustrated in FIG. 1, server 102 includes a processor 168. Although illustrated as a single processor 168 in FIG. 1, two or more processors may be used according to particular needs, desires, or particular embodiments of environment 100. Each processor 168 may be a central processing unit (CPU), a blade, an application specific integrated circuit (ASIC), a field-programmable gate array (FPGA), or another suitable component. Generally, processor 168 executes instructions and manipulates data to perform the operations of server 102 and, specifically, the one or more plurality of applications 170. Specifically, the server's processor 168 executes the functionality required to receive and respond to requests from client system 150 and respective client applications 154 or other servers 104 and 106 in environment 100, as well as the functionality required to perform the other operations of the application 170 and delivery module 172.

Regardless of the particular implementation, “software” may include computer-readable instructions, firmware, wired or programmed hardware, or any combination thereof on a tangible, non-transitory, medium operable when executed to perform at least the processes and operations described herein. Indeed, each software component may be fully or partially written or described in any appropriate computer language including C, C++, Java, Visual Basic, assembler, Perl, any suitable version of 4GL, as well as others. Some software may be associated with BPM notations including BPMN, BPEL, UML state charts, event-driven process chains (EPC), Petri Nets, and the like. It will be understood that while portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. In the illustrated environment 100, processor 168 executes one or more applications 170 and/or delivery module 172 on server 102.

At a high level, each of the one or more applications 170 is any application, program, module, process, or other software that may execute, change, delete, generate, or otherwise manage information according to the present disclosure, particularly in response to and in connection with one or more requests received from the illustrated client system 150 and its associated client applications 154 or from other servers or components through a network 112. In certain cases, only one application 170 may be located at a particular server 102. In others, a plurality of related and/or unrelated applications 170 may be stored at a single server 102, or located across a plurality of other servers, as well. In certain cases, environment 100 may implement a composite application 170. For example, portions of the composite application may be implemented as Enterprise Java Beans (EJBs) or design-time components may have the ability to generate run-time implementations into different platforms, such as JEE (Java Platform, Enterprise Edition), ABAP (Advanced Business Application Programming) objects, or Microsoft's .NET, among others.

Additionally, one or more of the applications 170 may represent web-based applications accessed and executed by remote system 150 or client applications 154 via the network 112 (e.g., through the Internet). Further, while illustrated as internal to server 102, one or more processes associated with a particular application 170 may be stored, referenced, or executed remotely. For example, a portion of a particular application 170 may be a web service associated with the application that is remotely called, while another portion of the application 170 may be an interface object or agent bundled for processing at a client system 150. Moreover, any or all of the applications 170 may be a child or sub-module of another software module or enterprise application (not illustrated) without departing from the scope of this disclosure. Still further, portions of the application 170 may be executed by a user working directly at server 102, as well as remotely at client system 150.

As illustrated, server 102 can also include a delivery module 172. The delivery module 172 may be one of the applications 170 executed by processor 168. In some implementations, the delivery module 172 identifies software components that will be deployed on a client system 150 or another system. In certain instances, the delivery module 172 delivers the software components to the client system 150 for installation on the client system 150 while in other instances, the delivery module 172 delivers intermediate artifacts (e.g., intermediate files) associated with certain software components without delivering the source code of the software components to the client system 150. In some cases, the delivery module 172 may package parts of a software component or parts from different software components for delivery to the client system 150. In such cases, only changed artifacts, including documentation artifacts, are delivered and deployed, and the operations described below may be applied only to the changed artifacts. Accordingly, although the examples in the present disclosure may refer to a software component, the generation of documentation as described below may also apply to portions of software components, such as changed artifacts.

The delivery module 172 may further be configured to identify source or intermediate artifacts and binary files (e.g., libraries, executable files, etc.) associated with the identified software components, and to package the intermediate artifacts with the binary files associated with the software components for delivery to the client system 150. Intermediate artifacts may include files (e.g., XML files) containing information associated with software components that may be used to generate technical documentation but that do not necessarily contain implementation details. For example, in a Java implementation, the intermediate artifact may contain a method signature, decorated with JavaDoc tags, but no method body. In some instances, intermediate artifacts may be associated with a format that is normalized or unified across different technologies (e.g., Java, WSDL, etc.), which may allow the intermediate artifacts to be used in service oriented architecture (SOA) systems, for example. Source artifacts may include by-products produced during the development of software components. Examples of source artifacts may include, for example, use cases, class diagrams, models, requirements, intermediate-level documentation, executable files, and design documents. Intermediate artifacts or source artifacts may be delivered together with libraries associated with software components to the client system 150 so that technical documentation of the software components may be generated at the client system 150 based on the artifacts.

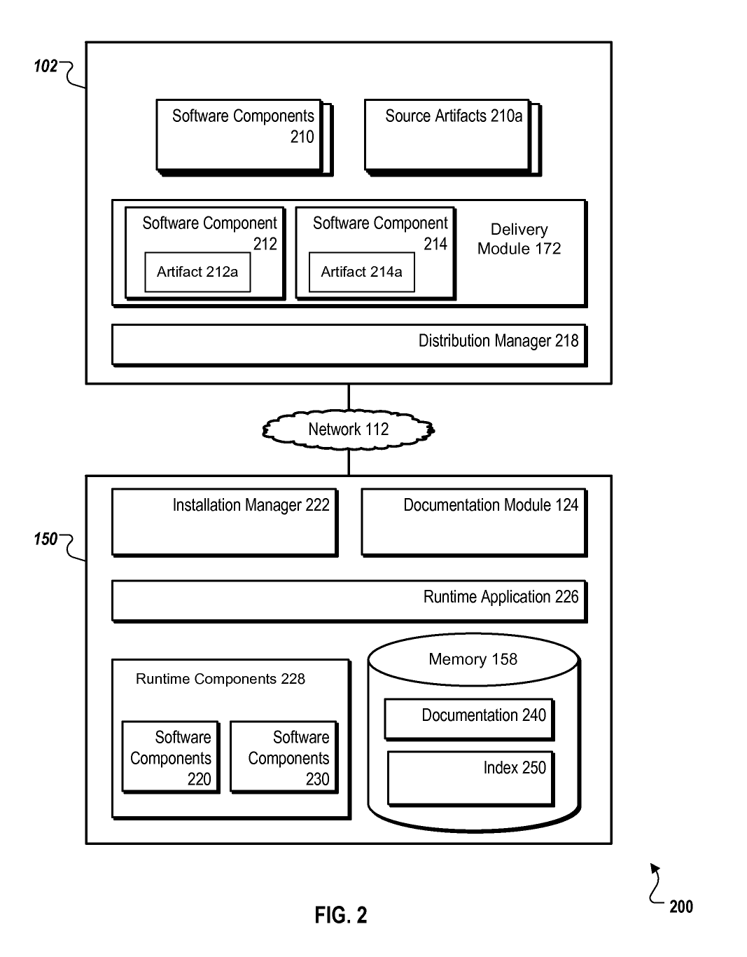

The delivery module 172 may be separate from application 170, while in other instances, the delivery module 172 may be embedded within or part of a particular one or more hosted applications. In some instances, application 170 may be communicably coupled to the delivery module 172, allowing application 170 to access and take advantage of the functionality provided by the delivery module 172. One example of an implementation of the delivery module 172 is described in detail below in connection with FIG. 2.

In general, server 102 also includes memory 161 for storing data and program instructions. Memory 161 may include any memory or database module and may take the form of volatile or non-volatile memory including, without limitation, magnetic media, optical media, random access memory (RAM), read-only memory (ROM), removable media, or any other suitable local or remote memory component. Memory 161 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of server 102 and its one or more applications 170.

Memory 161 may also store data objects such as software components 164 and source artifacts 166. In some implementations, software components 164 may be any binary unit that exports and imports functionality using a standardized interface mechanism. Software components 164 may represent one or more logical or organization-related processes or tasks. The underlying infrastructure of a software component 164 may support composition of components by providing mechanisms for introspection, event-handling, persistence, dynamic linking, and layout management. In certain instances, software components 164 may be independent of a particular system, language, platform, application, or tool. Accordingly, software components 164 may be integrated with other software components from different providers, for example, into a common system. Artifacts 166 may include intermediate artifacts (e.g., XML files) or source artifacts, which may be any by-product produced during development of software, including use cases, class diagrams, models, requirements, source code files, documentation, executable files, and design documents. The artifacts 166 may be used to generate documentation for associated software components 164. Memory 161 may also store binary files such as libraries or executable files that may be delivered to a client system 150 for deployment of software components 164 to the client system 150.

The illustrated environment of FIG. 1 also includes one or more clients 150. Each client 150 may be any computing device operable to connect to or communicate with at least the server 102 and/or via the network 112 using a wireline or wireless connection. In some implementations, as illustrated in FIG. 1, client 150 can also include a processor 156, an interface 155, a graphical user interface (GUI) 152, a client application 154, and a memory 158. In general, client 150 comprises an electronic computer device operable to receive, transmit, process, and store any appropriate data associated with the environment 100 of FIG. 1. It will be understood that there may be any number of clients 150 associated with, or external to, environment 100. For example, while illustrated environment 100 includes one client 150, alternative implementations of environment 100 may include multiple clients communicably coupled to the server 102, or any other number of clients suitable to the purposes of the environment 100. Additionally, there may also be one or more additional clients 150 external to the illustrated portion of environment 100 that are capable of interacting with the environment 100 via the network 112. Further, the terms “client,” “customer,” and “user” may be used interchangeably as appropriate without departing from the scope of this disclosure. Moreover, while each client 150 is described in terms of being used by a single user, this disclosure contemplates that many users may use one computer, or that one user may use multiple computers.

In certain implementations, client 150 may execute a documentation module 157. Documentation module 157 may include any software module, application, process agent, function, or program executed by processor 156. Documentation module 157 may be configured to receive software components 164, artifacts 166, or binary files 167 from server 102 for deployment on client 150 and generate documentation for the software components 164 based on the artifacts 166 or binaries 167 received from server 102. One example of an implementation of the documentation module 157 is described in detail below in connection with FIG. 2.

The GUI 152 associated with client 150 comprises a graphical user interface operable to, for example, allow the user of client 150 to interface with at least a portion of the platform for any suitable purpose, such as creating, preparing, requesting, or analyzing data, as well as viewing and accessing source documents associated with business transactions. Generally, the GUI 152 provides the particular user with an efficient and user-friendly presentation of business data provided by or communicated within the system. The GUI 152 may comprise a plurality of customizable frames or views having interactive fields, pull-down lists, and buttons operated by the user. For example, GUI 152 may provide interactive elements that allow a user to enter, modify, select, or model elements of business process instances in GUI 152. A view of source code, artifacts, or documentation associated with a software component may be presented and accessible to the user through GUI 152, such as through a web browser, for example. More generally, GUI 152 may also provide general interactive elements that allow a user to access and utilize various services and functions of application 154. The GUI 152 is often configurable, supports a combination of tables and graphs (bar, line, pie, status dials, etc.), and is able to build real-time portals, where tabs are delineated by key characteristics (e.g., site or micro-site). Therefore, the GUI 152 contemplates any suitable graphical user interface, such as a combination of a generic web browser, intelligent engine, and command line interface (CLI) that processes information in the platform and efficiently presents the results to the user visually.

As used in this disclosure, client 150 is intended to encompass a personal computer, touch screen terminal, workstation, network computer, kiosk, wireless data port, smart phone, personal data assistant (PDA), one or more processors within these or other devices, or any other suitable processing device. For example, each client 150 may comprise a computer that includes an input device, such as a keypad, touch screen, mouse, or other device that can accept user information, and an output device that conveys information associated with the operation of the server 102 (and application 170) or the client 150 itself, including digital data, visual information, client application 154, or GUI 152. Both the input and output device may include fixed or removable storage media such as a magnetic storage media, CD-ROM, or other suitable media to both receive input from and provide output to users of client 150 through the display, namely, GUI 152. Further, although client 150 is described as a client system with respect to server 102, in some instances, client system 150 may also operate as a server for other client systems. For example, client 150 may receive software components 164, artifacts 166, and binary files 167 from server 102, but a user of client 150 may also develop an application or framework for delivery to other client systems based on the received software components 164 and files.

While FIG. 1 is described as containing or being associated with a plurality of elements, not all elements illustrated within environment 100 of FIG. 1 may be utilized in each alternative implementation of the present disclosure. For example, although FIG. 1 depicts a server 102 external to network 112, servers may be included within the network 112 as part of a cloud network solution, for example. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

FIG. 2 illustrates an example diagram 200 of modules and data objects used to provide self-documentation of software components in an environment, such as the environment depicted in FIG. 1. Certain elements of FIG. 2 are illustrated as individual modules or objects for illustration purposes. The functionality or uses associated with individual modules or objects may also be included in a fewer, or greater, number of elements. For example, a single module, agent, or application may perform functions described herein as being associated with multiple modules (e.g., delivery module 172 and distribution manager 218). Further, the modules described in FIG. 2 may include stand-alone applications, functions within an application, software agents, methods, and the like.

As depicted in FIG. 2, a server 102 may be associated with a provider of software components 210. The software components 210 may be provided to a client system 150 for deployment of the software components 210 on the client system 150. For example, software components 210 may include software development kits distributed by a software provider to customers who may develop applications based on the software development kits. As used in the present example, software components 210 include binary files such as libraries and executable files. In some instances, the source code of the software components 210 may not be delivered to the client system 150. In the present example, the client 150 represents a “customer” of the provider associated with server 102 in a vendor-customer relationship in which the provider supplies software components 210 to a customer at client 150, who may need technical documentation for the software components 210 to develop applications based on the software components 210. Although only one client 150 is illustrated in FIG. 2, the provider associated with server 102 may distribute software components 210 to a plurality of clients.

The software components 210 developed by the provider at server 102 may be associated with source artifacts 210a. In general, source artifacts 210a may include files or data that are part of a software system and that are produced during development of software components 210. The source artifacts 210a may provide useful information for generating documentation for software components 210. Although FIG. 2 illustrates the delivery and use of source artifacts 210a for generating documentation at the client 150, the software components 210 may also be associated with intermediate files, such as XML files, which may also be delivered to the client 150 for generating documentation at the client 150.

In some implementations, server 102 includes a distribution manager 218 operable to manage the distribution of software components 210 to client 150. For example, the distribution manager 218 may receive and process requests from client 150 for particular software components 212 and 214 for deployment on the client 150. In certain instances, distribution manager 218 may determine which of multiple clients or locations to send the software components 212 and 214 to. Software components 212 and 214 may be designated for delivery to client 150 in response to a request received from client 150 or in response to a provider-initiated distribution or upgrade, for example.

In certain implementations, server 102 includes a delivery module 172 to prepare the software components 210 and source artifacts 210a prior to delivery to a client 150. Delivery module 172 may identify particular software components 212 and 214 requested for delivery to client 150 and identify the source artifacts 212a and 214a associated with the requested software components 212 and 214. In some cases, delivery module 172 may package each software component 212 and 214 with its respective source artifacts 212a and 214a in preparation for delivery to the client 150. Software components and source artifacts may be packaged into delivery units, such as Java Archive (JAR) files, for example, suitable for transmission to the client 150.

As illustrated in FIG. 2, the delivery units containing the software components 212 and 214, and their associated source artifacts 212a and 214a, may be transmitted to client 150 across a network 112. In some implementations, client 150 includes an installation manager 222 for managing installation of software components at the client system 150. The installation manager 222 may be configured to send requests to server 102 for particular software components, receive software components 212 and 214 from server 102, determine requirements for installation of the software components 212 and 214, perform any pre-processing tasks required before installation, and manage installation of the software components 212 and 214 on the client 150.

Client 150 may also include a documentation module 124 for generating documentation 240 of software components 212 and 214 to be installed at the client 150. Generating documentation for software components may include resolving references between documents or source artifacts associated with software components currently installed or to be installed at the client 150. For example, currently installed classes may need to reference a new class contained in software component 212. The existing documentation associated with the currently installed classes may be updated by generating a link in the existing documentation to new documentation 240 associated with the new class in software component 212. Further, documentation module 124 may call an existing documentation generator application, such as a Javadocs generator, for example, to generate documentation for software components.

In some instances, documentation module 124 generates documentation for software components that are designated for installation on the client 150 based on the source artifacts received with the software components. Further, the documentation may be generated immediately prior to, or approximately at the time of, installation of the software components in order to provide documentation that includes updated information relevant to the current installation of software components. Accordingly, the customer associated with client 150 is provided with documentation corresponding to the customer's business scenario.

Documentation module 124 may also be configured to manage the storage and distribution of software components and the documentation associated with the software components for use by runtime application 226. In some instances, runtime application 226 may access runtime components 228, which may include software components 220 and 230, for example. Software components 220 and 230 may include existing software components currently installed at the client 150 as well as software components 212 and 214 received from server 102 that are designated for installation at the client 150. In some instances, documentation module 124 may store documentation 240 in a memory 158 at the client 150. Documentation module 124 may also be configured to update an index 250 of software components and documentation located at the client 150.

In situations in which software components associated with different technologies may be deployed at the client 150, such as in a service-oriented architecture (SOA) system, documentation module 124 may also be configured to determine a particular programming language associated with the received software components 212 and 214, and to select a suitable documentation generator application (e.g., Javadocs generator) for generating documentation corresponding to the technology or programming language of the software components 212 and 214. Further, a plurality of software components may be received from server 102 for installation on client 150. The documentation module 124 may generate documentation for each of the plurality of software components based on the source artifacts associated with each of the software components. In some instances, however, some of the received software components may not be designated for installation at client 150 while other software components are designated for installation at client 150. Accordingly, documentation module 124 may generate documentation for the software components designated for installation while bypassing the other software components that are not to be installed at client 150.

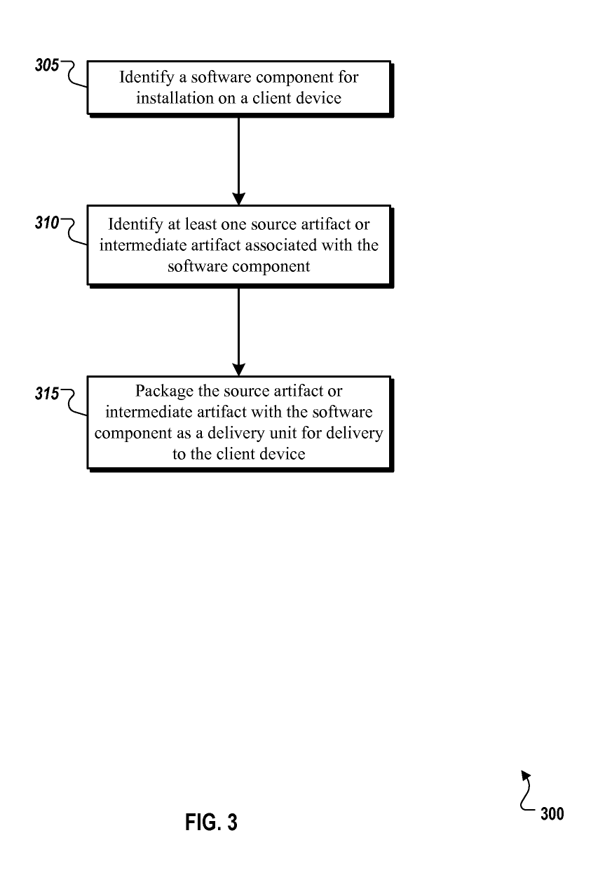

FIG. 3 illustrates an example process 300 for delivering software components to a client prior to generating documentation for the software components. First, a software component is identified for installation on a client device, such as client system 150, at 305. In some cases, the identification of the software component is in response to a request received from the client device. In other cases, the identification of the software component for installation on the client device may be triggered by initiation of a software upgrade supplied by the provider of a software system currently installed at the client device, and the identified software component may be part of the software upgrade.

At least one source artifact or intermediate artifact associated with the software component is identified at 310. The source artifacts or intermediate artifacts may have been generated during development of the software component. The source artifact or intermediate artifact is packaged with the software component as a delivery unit for delivery to the client device for generation of source documentation of the software component at the client device at 315. For example, the software component may include a number of Java classes, and the delivery unit may include both the Java classes and the source artifacts associated with the Java classes. In some instances, the software component is represented by the binary files associated with the software component, and the delivery unit is comprised of the binary files and source artifacts or intermediate artifacts associated with the software component.

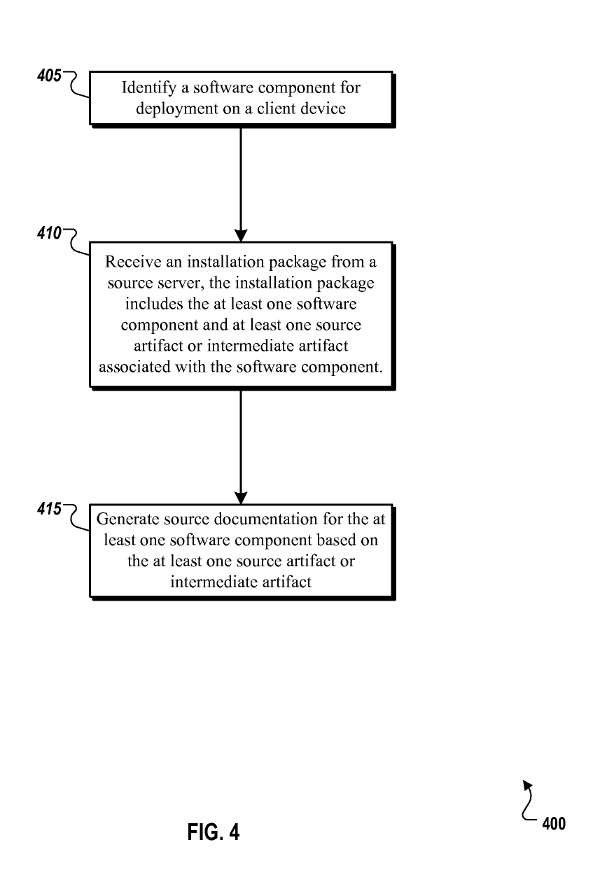

FIG. 4 illustrates an example process 400 performed by the documentation module 124 for generating documentation for software components to be installed at a client system. The documentation module 124 identifies a software component for deployment on a client device at 405 and receives an installation package from a source server at 410. In some instances, the installation package includes the at least one software component and at least one source artifact or intermediate artifact associated with the software component. The documentation module 124 generates source documentation for the at least one software component based on the at least one source artifact or intermediate artifact at 415.

The documentation module 124 may generate documentation at different times according to the implementation or context. For example, documentation module 124 may generate documentation during deployment of the software components on the client device. Alternatively, or in addition, documentation module 124 may be configured to generate, or update, documentation in response to a request from a user for updated documentation or a particular page of existing documentation associated with a software component designated for installation on the client device. In some instances, documentation module 124 may be configured to generate or update documentation asynchronously or in a background process to allow the user to concurrently perform other tasks. The documentation may also be generated at a predetermined time, such as at a time when system resources are likely to be available, for example.

In certain implementations, documentation module 124 may update or generate new documentation directed at capturing changes to source artifacts or intermediate artifacts associated with installed software components. For example, documentation may be regenerated during a start-up phase of a deployment platform after the deployment platform restarts. Similarly, documentation module 124 may automatically trigger regeneration of documentation in response to software upgrades applied to a deployment platform or to specific software components. Accordingly, documentation module 124 may generate source documentation in response to a change in a particular source artifact or intermediate artifact.

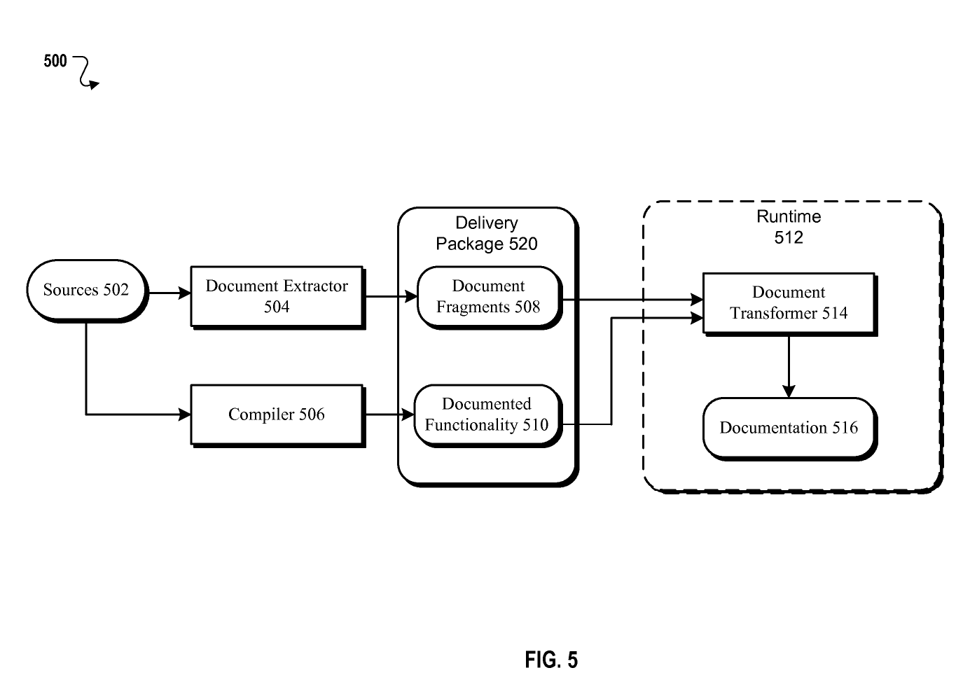

FIG. 5 illustrates an example diagram and flow 500 of objects and modules used to generate documentation from source artifacts for software components in a service-oriented architecture (SOA). In a SOA environment, technical documentation may be helpful to describe uses of various functions associated with different technologies or domains within a SOA system. In particular, the different technologies associated with a SOA system may use different runtime artifacts, packaging models, and the like. For example, a composite application in a SOA system may be comprised of a combination of Java components (e.g., APIs accessed through client libraries), standard JEE technologies (e.g., servlets, Java Beans, Java Management Extensions (JMX) MBeans, Java Persistence API (JPA), etc.), proprietary technologies, web services, or Representational State Transfer (“RESTful”) services. Similar to the processes described above with respect to FIGS. 3 and 4, in a SOA environment, software components may be delivered together with associated source artifacts to the runtime system, where documentation is generated with the appropriate scope relevant to the present installation of the software components.

First, source code files 502 are passed to a document extractor 504 and a compiler 506. The document extractor 504 may be configured to extract document fragments 508, including binary files such as libraries or executable files, from the source code. The compiler 506 may be configured to generate documented functionality 510 for deployment to a client device. In some instances, the documented functionality 510 is in the form of source code to be delivered to the runtime environment 512, such as at a client, where documentation can be generated from the source code and document fragments 508. The document fragments 508 and documented functionality 510 may be combined into a delivery package 520 for delivery to a runtime environment 512. Delivery package 520 may include any delivery unit suitable for transmitting the document fragments 508 and documented functionality 510 to a client device. Examples of such delivery units may include Java Archive (JAR) files, Software Deployment Archive (SDA) files, or Software Component Archive (SCA) files. In some instances, the runtime environment 512 may be provided at a client device. During runtime, the document fragments 508 and documented functionality 510 are pulled from the delivery package 520 and passed to a document transformer 514 for transformation into “end” documentation 516 with the appropriate scope for consumption by a user. The document transformer 514 may be configured to generate documentation 516 for particular software components on deployment of the software components, on demand in response to requests for documentation from a user, or on first access of a particular function or software component. In some implementations, the document transformer 514 may first generate intermediate artifacts before generating end documentation 516 based on the intermediate artifacts.

In a SOA system, documentation may be needed for a plurality of different technologies, programming languages, or systems. Accordingly, multiple document extractors or document transformers may be included, such as a different document extractor or document transformer for each particular technology in the SOA system. The plurality of document extractors and/or document transformers may provide for single-entry-point documentation for different technologies in a unified format, such as in an HTML representation, for example.

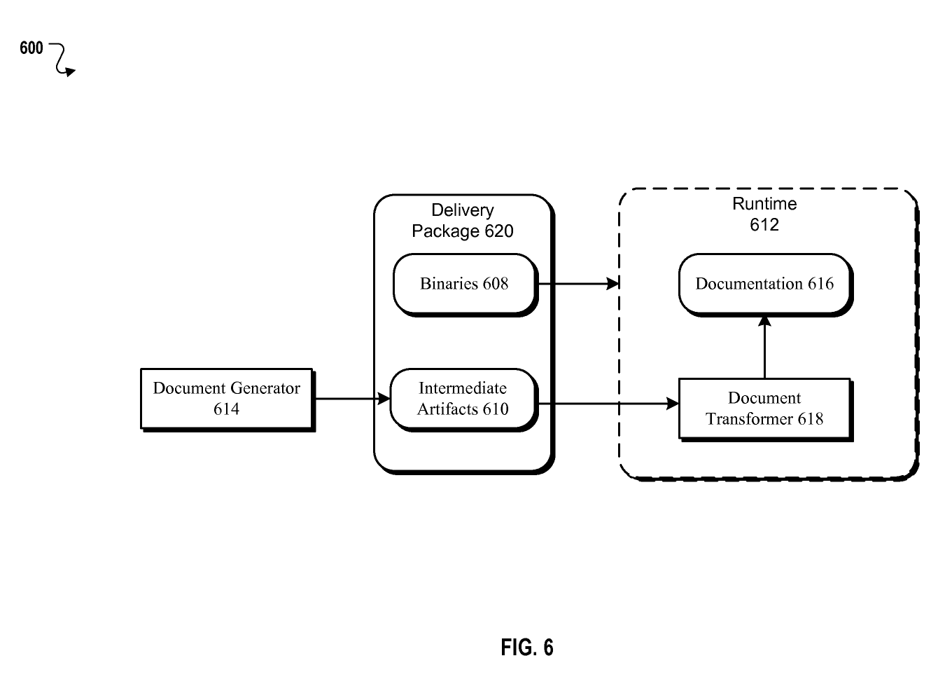

FIG. 6 illustrates another example diagram and flow 600 of objects and modules used to generate documentation from intermediate artifacts for software components in a service-oriented architecture (SOA). Instead of packaging source code with binary files for delivery to the client as illustrated in FIG. 5, and generating intermediate artifacts at the client, where the end documentation 616 is generated, the intermediate artifacts may be generated at the server and then delivered to the client as depicted in FIG. 6.

First, a document generator 614 may generate intermediate artifacts 610 based on source code associated with a software component. The intermediate artifacts 610 may be intermediate files that provide information for generating technical documentation but without implementation details. Examples of intermediate artifacts may include documentation relevant tags, such as JavaDoc tags. In some instances, intermediate artifacts may be associated with a format that is normalized or unified across different technologies (e.g., Java, WSDL, etc.), which may allow the intermediate artifacts to be used in service oriented architecture (SOA) systems. The intermediate artifacts 610 may be packaged with binary files 608 associated with the source code of the software component into a delivery package 620. The delivery package 620 is delivered to the runtime environment 612, where a document transformer 618 may transform the intermediate artifacts into end user documentation 616 that may be consumed by an end user.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method performed by one or more processors for self-documenting development systems, the method comprising the following operations:
identifying at least one software component for deployment on a client device;
receiving an installation package from a source server, the installation package including the at least one software component and at least one artifact associated with the software component; and
generating source documentation for the at least one software component based on the at least one artifact.

2. The method of claim 1, wherein generating source documentation is performed during deployment of the at least one software component or a portion of the at least one software component on the client device.

3. The method of claim 1, wherein generating source documentation is performed in response to a request for a page of documentation associated with the at least one software component.

4. The method of claim 1, wherein generating source documentation is performed as a background process at a predetermined time.

5. The method of claim 1, wherein generating source documentation is performed in response to a change in a particular artifact associated with the software component.

6. The method of claim 1, wherein generating source documentation is performed during a restart of a platform associated with the at least one software component when a change has occurred to at least one artifact associated with the platform.

7. The method of claim 1, wherein generating the source documentation includes resolving at least one unresolved reference to a particular document different from the artifact.

8. The method of claim 1, wherein generating source documentation is performed by a Javadoc documentation generator.

9. The method of claim 1, wherein the software component represents a particular functionality of a software application comprised of a plurality of different software components.

10. The method of claim 9, further comprising:
receiving an installation package for each of the plurality of different software components from a source server, each installation package including one of the plurality of different software components and at least one source artifact associated with the one of the plurality of different software components; and
generating source documentation for each of the plurality of different software components based on the at least one source artifact associated with each of the plurality of different software components.

11. The method of claim 10, further comprising identifying a particular one of the plurality of different software components that is not designated for installation on the client device; and bypassing the particular software component when generating source documentation for each of the plurality of different software components.

12. The method of claim 1, wherein the source code documentation includes a Javadoc comment.

13. The method of claim 1, wherein the artifact is a source artifact or an intermediate artifact.

14. The method of claim 1, wherein the software component includes a binary file.

15. A computer program product encoded on a non-transitory, tangible storage medium, the product comprising computer readable instructions for causing one or more processors to perform operations comprising:
identifying a software component for installation on a client device;
identifying at least one artifact associated with the software component; and
packaging the at least one artifact with a binary file associated with the software component for delivery to the client device for generation of source documentation of the software component at the client device.

16. The computer program product of claim 15, wherein the software component represents a particular functionality of a software application comprised of a plurality of different software components.

17. The computer program product of claim 15, wherein the artifact includes at least one unresolved reference to a particular document different from the artifact.

18. The computer program product of claim 15, wherein the at least one artifact is packaged with the binary file in a delivery unit including at least one of a Java Archive file, a Software Deployment Archive file, or a Software Component Archive file.

19. A system, comprising:
memory operable to store software components; and
one or more processors operable to:
identify at least one software component for deployment on the system;
receive an installation package from a source server, the installation package including the at least one software component and at least one source artifact or intermediate artifact associated with the software component; and
generate source documentation for the at least one software component based on the at least one source artifact or intermediate artifact.

20. The system of claim 19, wherein generating source documentation includes:
determining a programming language associated with the at least one software component and the at least one source artifact or intermediate artifact; and
selecting a documentation generator associated with the programming language for generating source documentation for the at least one software component.
